(19) United States
(12) Patent Application Publication
(10) Pub. No.: US 2023/0407930 A1
(43) Pub. Date: Dec. 21, 2023

(54) BRAKE PAD HAVING AN UNDERLAYER WITH AN ANISOTROPIC MATERIAL PROPERTY

(71) Applicant: HL MANDO CORPORATION, Pyeongtaek-si (KR)

(72) Inventors: Hatem SHAHIN, Pfaffenhofen (DE); Volker KINDER, Russelsheim (DE)

(21) Appl. No.: 18/212,275

(22) Filed: Jun. 21, 2023

(30) Foreign Application Priority Data
Jun. 21, 2022 (DE) 102022206154.3

(51) Int. Cl. F16D 65/04

(52) U.S. Cl. CPC F16D 65/04; F16D 2069/005

(57) ABSTRACT

The invention relates to a brake pad for a vehicle brake, comprising a back plate, an underlayer, and a friction material, stacked in this order, in a z-direction, wherein the brake pad is configured to be moved in the z-direction to be pressed against a rotating body for braking. The underlayer has an anisotropic material property, at least one material parameter having a value in the z-direction that is different from its value in a direction orthogonal to the z-direction.

### CROSS-REFERENCE TO RELATED APPLICATION

This application is based on and claims priority under 35 U.S.C. § 119 to German Patent Application No. 102022206154.3, filed on Jun. 21, 2022 in the German Patent and Trade Mark Office, the disclosures of which are incorporated herein by reference.

### TECHNICAL FIELD

The invention is in the field of mechanical engineering. It relates to vehicle technology, namely to vehicle brakes.

### BACKGROUND

It has been a focus of car manufacturers to reduce fuel consumption and CO₂ emissions. One aspect that may be improved in this regard is reduction of drag torque in the brakes. I.e., during driving, in a non-braking condition, clearance between brake disk and pads should be ensured. This clearance should be obtained as quickly as possible after the brakes are released, and then maintained. Solutions for reducing drag torque often have drawbacks regarding brake efficiency and/or pedal feel. Some solutions include using specific chamfers, seals, or seal groove designs. An aspect to be considered is that due to a hyperplastic homogeneous behaviour of seal material, the seal pushes the piston back towards the disk after the brakes are released.

### SUMMARY

In view of the above, it is an object of the invention to reduce drag torque, and enable maintaining a target gap between pads and disk surface.

This is for instance achieved by a brake pad according to claim 1, or by way of a brake pad as described here below. Advantageous embodiments can be found in the dependent claims, and in the following description and the figures.

According to this application, a brake pad for a vehicle brake comprises a back plate, an underlayer, and a friction material, stacked in this order, in a z-direction. The brake pad is configured to be moved in the z-direction to be pressed against a rotating body for braking.

The underlayer may have an anisotropic material property, wherein at least one material parameter has a value in the z-direction that is different from its value in a direction orthogonal to the z-direction.

Having this type of anisotropic material properties may facilitate retraction of the brake pad and/or maintaining a desired gap. In particular, the anisotropic material properties may be tuned to having contraction of the underlayer in the z-direction as the brake system cools down. Vice versa, brake pressure may be increased while the brakes are applied, as the underlayer expands under heat.

For example, the anisotropic material property is provided by
an anisotropic modulus of elasticity, and/or
an anisotropic shear modulus, and/or
an anisotropic Poisson's ratio, and/or
an anisotropic thermal conductivity, and/or
an anisotropic thermal expansion, and/or
an anisotropic compressibility, and/or
an anisotropic storage modulus, and/or
an anisotropic loss modulus.

According to this application, it may be envisioned that the underlayer comprises a base material and inlay elements disposed in the base material. The inlay elements may be arranged such that the aforementioned anisotropic material property is achieved for the underlayer as a whole. For example, choosing a material for the inlay elements and arranging them in specific sections of the underlayer and/or with a specific orientation results in anisotropic properties of the whole underlayer, which comprises the base material and the inlay elements. Specific configurations are given here below.

For example, the inlay elements may comprise rubber and/or minerals, such as stone, and/or glass and/or metal, such as steel, and/or phenol. The materials may be chosen and composed to achieve specific material properties.

In a possible embodiment, at least some of the inlay elements are elongated elements, such as fibers or sticks.

The elongated elements may be oriented in a principal direction. Specific orientations and/or arrangement in specific areas of the underlayer may effect or enhance anisotropy.

In an example, the elongated elements extend in the z-direction, i.e., they are lengthwise arranged predominantly along the z-direction, which is the axial direction of the brake system.

At least some of the inlay elements, for example the elongated elements, may have a diameter of at least 40 μm or at least 50 μm and/or at most 110 μm or at most 100 μm. Additionally or alternatively, they may have a length of at least 0.4 mm or at least 0.5 mm and/or at most 3 mm or at most 2 mm.

Additionally or alternatively, at least some of the inlay elements may have a diameter of at most 50 μm and/or a length of at most 0.1 mm. In possible embodiments, these inlay elements are oriented in a principal direction. It may also be envisioned that they are not oriented in a principal direction.

More specifically, in possible embodiments, there may be elongated elements having the above-mentioned dimensions, which are arranged along a principal direction, and there may be additional smaller inlay elements, which are not oriented in a specific way. Therein, the smaller elements may be provided in specific areas of the underlayer to contribute to a desired anisotropy.

For example, a higher density of inlay elements (referring to any kind of inlay elements, such as elongated inlay elements, larger inlay elements, or smaller inlay elements) may be provided in a border area near outer edges of the underlayer than in a central area of the underlayer. Then, the inlay elements in the border area may be seen as framing the central area of the underlayer. The central area may be devoid of inlay elements, or it may comprise a lower density of inlay elements.

Additionally or alternatively, a higher density of inlay elements may be provided in a vicinity of a backplate.

For example, the border area which has the increased density of inlay elements may be confined to a distance of at most 4 mm or at most 3 mm or at most 2 mm from an outer edge of the underlayer. Additionally or alternatively, the vicinity of the backplate with the higher density of inlay elements may be confined to a distance of at most 0.5 mm from the backplate. A remainder of the underlayer, away from the border area at the edges, and away from the area in the vicinity of the backplate, may be devoid of inlay elements, or comprise a lower density (such as volume density and/or mass density) of inlay elements, as compared to the border region and/or the vicinity of the backplate.

For example a distance between neighboring inlay elements, in particular elongated elements, in the border area is on average less than 0.5 mm or less than 0.3 mm or less than 0.1 mm. For example, at least some of the neighboring inlay elements (such as the elongated elements) in the border area are contacting each other.

For example, the thermal expansion coefficient of the inlay elements may be at least twice the thermal expansion coefficient of the base material. In a preferred optional embodiment, the thermal expansion coefficient of the inlay elements is at least three times the thermal expansion coefficient of the base material. By optionally arranging them along the z-direction, an expansion acts predominantly in the z-direction, which may be a desired effect.

For example, upon heating, a material of the inlay elements may have a thermal expansion of at least 1.0 E-1/K and/or at most 1.4 E-5 1/K and/or the base material may have a thermal expansion of at least 0.2 E-5 1/K and/or at most 0.4 E-5 1/K. Additionally or alternatively, upon cooling, the material of the inlay elements may have a thermal contraction of at least (in terms of absolute value) −3 E-6 1/K and/or at most (in terms of absolute value) −5 E-6 1/K and/or the base material may have a thermal contraction of at least (in terms of absolute value) −1.2 E-6 and/or at most (in terms of absolute value) −1.6 E-6 1/K.

In an embodiment of the brake pad, a density of inlay elements in the underlayer may be at least 10% or at least 15% and/or at most 40%. I.e., the inlay elements may constitute at least 10% or at least 15% and/or at most 40% of a volume and/or a mass of the underlayer. In an optional example, this is the case whereby the inlay elements are fibers or sticks, made of mineral, glass, or metal.

In an example, the underlayer is configured to expand in the z-direction by at least 0.1 mm or at least 0.2 mm when heated from 20° C. to 150° C. Therein, the expansion may preferably counteract a pressure of at least 5 bars. I.e., the expansion takes place even if a pressure of 5 bars, or preferably an even higher pressure, is being applied. A thickness of the underlayer may therein for instance be at least 1.5 mm or at least 2 mm and/or at most 3 mm and/or at most 3,5 mm, wherein this thickness may for instance be the thickness at room temperature.

In an example, the underlayer is configured to expand by at least 0.03 mm and/or at most 0.05 mm in the x-direction and/or in the y-direction, when heated from 20° C. to 150° C. In this sense, for example, the underlayer may be anisotropic, as it may be configured to expand more into the z-direction than the x-direction or the y-direction when heated.

For example, a resistance against compressibility of the underlayer may be at least 0.0008 mm³/bar and/or at most 0.0012 mm³/bar.

For example, the underlayer, in particular the base material of the underlayer, may comprise at least one of:
rubber,
adhesive,
phenol,
metal particles,
glass particles,
sand particles,
organic particles,
plastic particles.

### BRIEF DESCRIPTION OF DRAWINGS

The invention will now be explained in an exemplary fashion with reference to the appended figures.

Therein,

FIG. 1 shows a disk brake system,

FIG. 2 shows a brake disk with a brake pad in a non-braking condition,

FIG. 3 shows a brake disk with a brake pad in a braking condition,

FIG. 4 shows a brake disk with an underlayer having inlay elements,

FIG. 5 illustrates anisotropic material properties of the underlayer,

FIG. 6 shows an underlayer having elongated inlay elements, and

FIGS. 7-16 illustrate different distributions of inlay elements within an underlayer.

### DETAILED DESCRIPTION

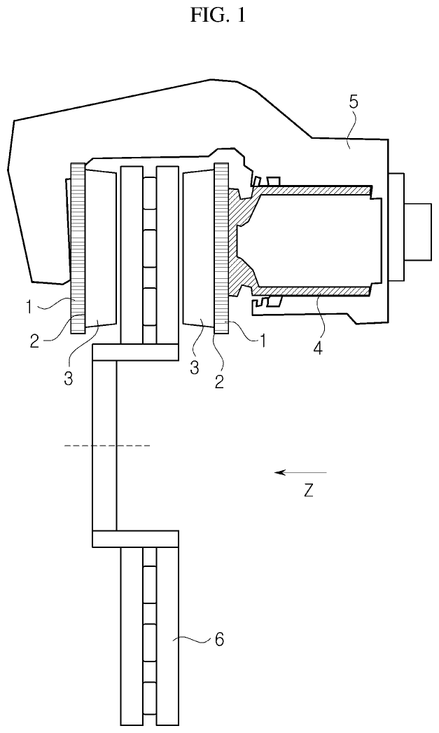

FIG. 1 shows a disk brake system, comprising a rotating body in the form of a brake disk 6, and a caliper 5. The caliper 5 holds a piston 4 and two brake pads, which are configured to be pressed against the brake disk 6. The brake pad on the right, which is connected to the piston 4, is configured to be moved in a positive z-direction for braking, as indicated by an arrow, and the opposing brake pad, which is held by a finger of the caliper 5, is configured to be moved in a negative z-direction for braking. After the brakes are released, both brake pads are moved away from the brake disk 6, and they should resume and maintain their non-braking position as reliably as possible, to avoid drag torque. Each brake pad comprises a back plate 1, an underlayer 2, and a friction material 3, which are stacked in this order along the z-direction (positive z-direction for the brake pad on the right, and, in a mirrored fashion, negative z-direction for the brake pad on the left). The underlayer 2 is more clearly visible in the following figures. As will be explained further here below, according to the present application, the underlayer 2 has an anisotropic material property, wherein at least one material parameter has a value in the z-direction that is different from its value in a direction orthogonal to the z-direction.

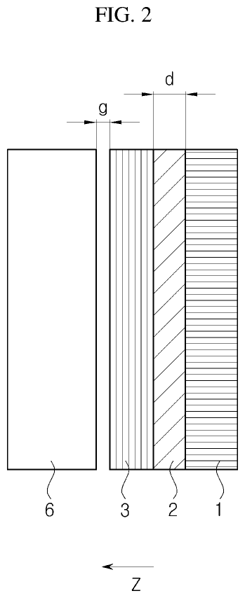

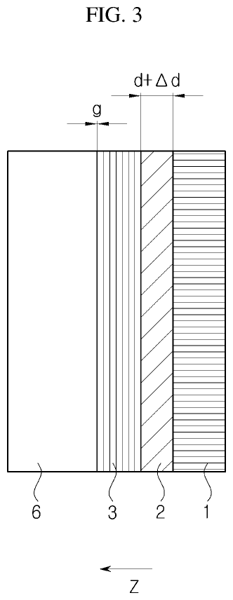

FIGS. 2 and c show enlarged views of a portion of the right brake pad, and a portion of the brake disk 6. FIG. 2 shows a non-braking condition, and FIG. 3 shows a braking condition.

In the non-braking condition of FIG. 2, a gap g between the brake disk 6 and the brake pad has a target gap width of 0.1 mm to 0.15 mm, which should be reliably resumed and maintained. A thickness d of the underlayer 2 has a value between 2 mm and 3 mm in the non-braking state.

As the brakes are applied (FIG. 3), the gap g disappears as the brake pads (i.e., the friction materials 3) are pressed against the brake disk 6. Heat generated by friction causes the underlayer 2 to increase in thickness by Δd, by way of thermal expansion. Therein, the underlayer is configured to expand in the z-direction by at least 0.1 mm when heated from 20° C. to 150° C., wherein this expansion along the axial z-direction takes place while counteracting a pressure of at least 5 bars. The heating and expansion for example takes place during a 15 s brake application. For example, Δd=0.12 mm. The underlayer 2 may thereby be configured to expand by between 0.03 mm and 0.05 mm in each of the x-direction and in the y-direction, when heated from 20° C. to 150° C. In this sense, the thermal expansion is anisotropic, because expansion in the axial z-direction exceeds thermal expansion in a direction along a plane that is orthogonal to the z-direction.

After brake release, the external load will disappear and accordingly heating of the underlayer 2 is stopped. As the underlayer 2 resumes a lower temperature, for example room temperature, the dimensions of the underlayer will return to their initial length, width, and height, in x-, y-, and z-directions.

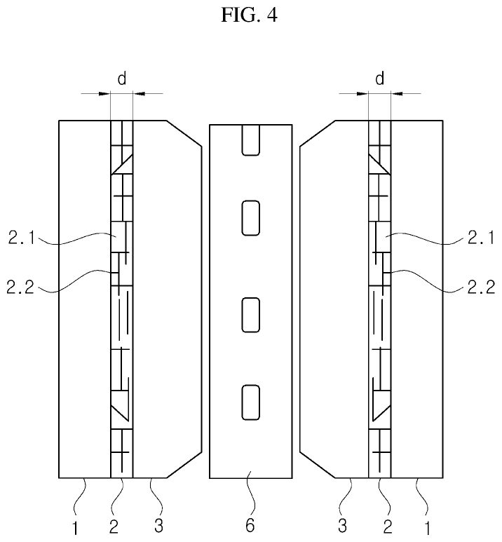

FIG. 4 shows a view of a portion of the brake disk 6 and two brake pads, each brake pad comprising a back plate 1, an underlayer 2, and a friction material 3. The underlayer 2 comprises a base material 2.1 and inlay elements 2.2 disposed in the base material 2.1. As will be explained further, the inlay elements 2.2 facilitate providing the anisotropic material properties for the underlayer 2.

Specifically, the underlayer 2 may be enforced by inlay elements in the form of, for example, hard metal pieces and/or glass pieces, with a very high resistance against compression and a high value of a coefficient of thermal expansion. For example, the inlay elements 2.2 may comprise rubber and/or minerals, such as stone, and/or glass and/or metal, such as steel, and/or phenol.

The base material 2.1 of the underlayer 2 may comprise at least one of rubber, adhesive, phenol, metal particles, glass particles, sand particles, organic particles, plastic particles.

The inlay elements 2.2 have a bulk modulus that is for example 4 to 5 times the bulk modulus of the base material 2.1.

The inlay elements 2.2 have a thermal expansion coefficient that is for example at least 3 times the thermal expansion coefficient of the base material 2.1.

For example, upon heating, a material of the inlay elements has a thermal expansion of 1.0 E-1/K to 1.4 E-5 1/K and the base material has a thermal expansion of 0.2 E-5 1/K to 0.4 E-5 1/K. For example, upon cooling, the material of the inlay elements has a thermal contraction of −3 E-6 1/K to −5 E-6 1/K and the base material has a thermal contraction of −1.2 E-6 to −1.6 E-6 1/K.

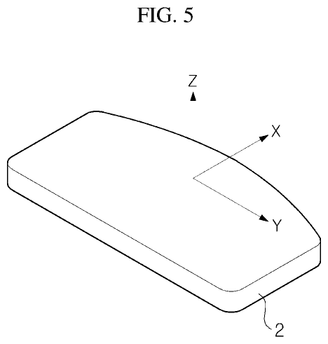

FIG. 5 shows the underlayer 2 according to the application, wherein the axial z-axis is denoted, as well as the x- and y-directions which are perpendicular to the z-direction. As mentioned above, the underlayer 2 as a whole has anisotropic material properties. These anisotropic material properties, may be provided by
an anisotropic modulus of elasticity, and/or
an anisotropic shear modulus, and/or
an anisotropic Poisson's ratio, and/or
an anisotropic thermal conductivity, and/or
an anisotropic thermal expansion, and/or
an anisotropic compressibility, and/or
an anisotropic storage modulus, and/or
an anisotropic loss modulus.

For example, an anisotropic modulus of elasticity E may exemplarily have the following tensor components (in MPa):
Eₓₓ=14500 (from 12000 to 18000)
E_{yy}=14500 (from 12000 to 18000)
E_{zz}=4600 (from 2500 to 7500)

An anisotropic shear modulus G may exemplarily have the following tensor components (in MPa):
G_{xz}=3800 (from 1800 to 6800)
G_{yz}=3800 (from 1800 to 6800)
G_{xy}=6200 (from 4000 to 9500)

An anisotropic poisson's ratio v may exemplarily have the following tensor components (dimensionless):
V_{xz}=V_{yz}=0.15 (from 0.12 to 0.18)
V_{zx}=V_{zy}=0.08 (from 0.05 to 0.10)
V_{xy}=V_{yx}=0.25 (from 0.18 to 0.30)

A density of the underlayer 2 for for instance be 2.3 gr/cm³ (from 2.0 to 2.5). A resistance against compressibility of the underlayer 2 is at least 0.0008 mm³/bar and/or at most 0.0012 mm³/bar.

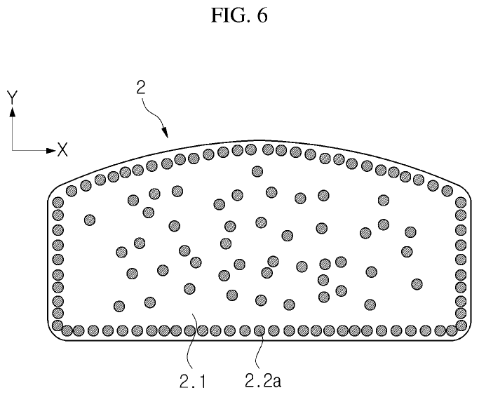

FIG. 6 shows a cut through an underlayer 2 with directionally oriented inlay elements 2.2 disposed in the base material 2.1, according to an embodiment of the application. The inlay elements 2.2 are elongated elements 2.2a. More specifically, the shown inlay elements 2.2 are fibers or sticks, for example made of metal and/or glass. They have an approximately circular cross section. They are lengthwise oriented along the z-direction as a principal direction, i.e., they extend in the z-direction.

The elongated elements 2.2a have a diameter of between 50 μm and 100 μm and a length of between 0.5 mm and 2 mm, for example, wherein the length of the elongated elements 2.2a oriented along the z-direction does typically not exceed the thickness of the underlayer 2.

As can be seen from FIG. 6, a density of the elongated inlay elements 2.2 is increased in a border area near outer edges of the underlayer 2, as compared to the density of the elongated inlay elements in a central area of the underlayer 2. The border area is a region that extends to up to 2 mm from an outer edge of the underlayer 2, for example. The central area is the portion of the underlayer 2 which is surrounded by the border area. The inlay elements 2.2 thus form a frame around the central area of the underlayer 2. In the border area, a distance between neighboring inlay elements 2.2, which are carried out as elongated elements 2.2a, is on average less than their thickness, i.e. less than 0.1 mm, for example, wherein some of the neighboring inlay elements in the border area are contacting each other, resulting in a regionally comparatively high volume density of inlay elements 2.2 (volume of inlay elements 2.2 per volume of the underlayer 2). Compared to this, the volume density of inlay elements 2.2 in the central area is reduced, as the inlay elements 2.2 are arranged in a more dispersed manner.

An overall average volume density of inlay elements in the underlayer 2 is between 10% and 40%.

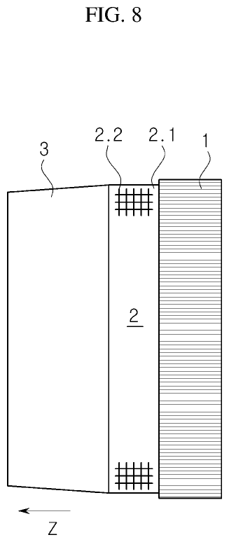

The arrangement of inlay elements 2.2 as shown in FIG. 6 facilitates providing the anisotropic material properties. Further embodiments aimed at providing the anisotropic material properties are shown in FIGS. 8-j.

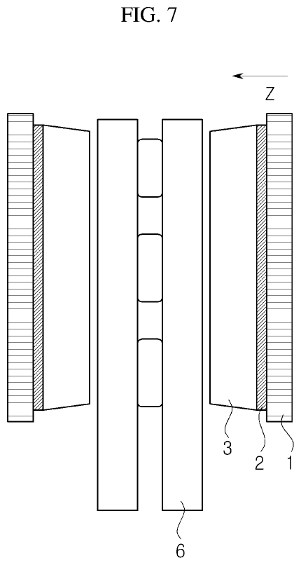

FIG. 7 illustrates once again an overview over a brake system, wherein a cut view illustrates the brake disk 6 and two brake pads, each brake pad having a back plate 1, an underlayer 2, and a friction material. In the following FIGS. 8-16, embodiments of the brake pad according to this application are shown, exemplarily with reference to the right brake pad, which is configured to be moved in the positive z-direction for braking. All statements made apply to the left brake pad as well, mutatis mutandis.

FIG. 8 shows an embodiment of the brake pad, wherein the underlayer 2 has a base material 2.1 and inlay elements 2.2, the inlay elements 2.2 being exclusively disposed in a border area of the underlayer 2, at a distance of at most 3 mm or at most 2 mm from outer edges of the underlayer 2.

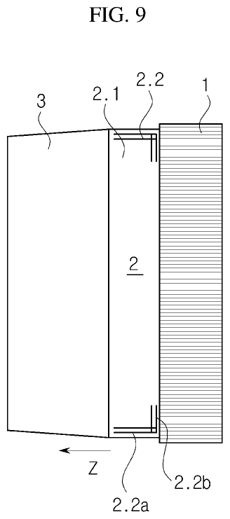

FIG. 9 shows an embodiment of the brake pad, wherein the inlay elements 2.2 comprise elongated elements 2.2a that are disposed in a border area of the underlayer 2 and extend in the z-direction. Additionally, the inlay elements 2.2 comprise further inlay elements 2.2b extending in the vicinity of the backplate 1, for example orthogonally to the z-direction. The further inlay elements 2.2b may be made of the same material or of a different material from the elongated elements 2.2a extending in the z-direction. The elongated elements 2.2a extending in the z-direction are confined to a distance of at most 3 mm or at most 2 mm from an outer edge of the underlayer 2. The further inlay elements 2.2b are confined to a distance of at most 0.5 mm from the backplate. The further inlay elements 2.2b extend by up to 1 cm towards the center of the underlayer 2, away from the outer edge of the underlayer 2.

All of the inlay elements 2.2 may have a diameter of for example between 50 μm and 100 μm.

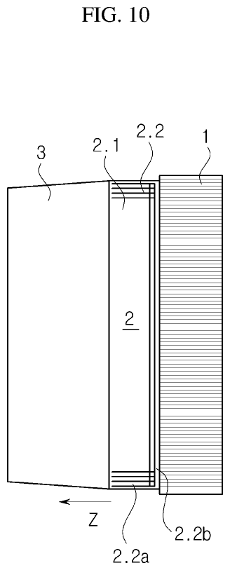

FIG. 10 shows an embodiment of the brake pad, wherein, similar to the embodiment of FIG. 9, elongated elements 2.2a extending in the z-direction are provided, which are confined to the border region, up to 3 mm or up to 2 mm from the outer edge of the underlayer. Additionally, further inlay elements 2.2b are provided at a distance of at most 0.5 mm from the backplate 1, wherein the further inlay elements 2.2b extend throughout the underlayer, for example all the way across the underlayer. The further inlay elements 2.2b may be made of the same material or of a different material from the elongated elements 2.2a extending in the z-direction.

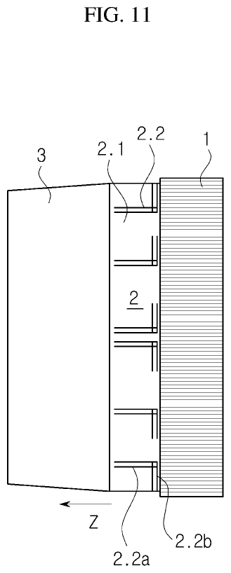

FIG. 11 shows an embodiment of the brake pad, wherein a plurality of the elongated elements 2.2a extending in the z-direction is provided. The elongated elements 2.2a are dispersed throughout the volume of the underlayer 2 and accordingly, they are not confined to any border region of the underlayer 2. Further inlay elements 2.2b extending orthogonally to the z-direction are also provided. The further inlay elements 2.2b are confined to a distance of at most 0.5 mm from the back plate 1.

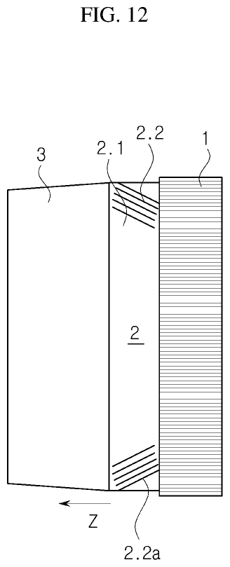

FIG. 12 shows an embodiment wherein elongated elements 2.2a are oriented in a principal direction which deviates slightly from the z-direction, the elongated elements deviating from the z-direction by an angle of for example 30 degrees or less. Therein, the elongated elements 2.2a are angled outwards, towards the outer edge of the underlayer 2, in the positive z-direction.

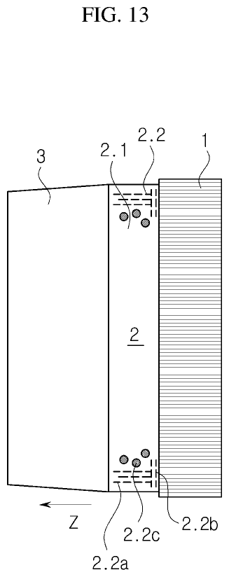

FIG. 13 shows an embodiment of the brake pad, wherein a plurality of different inlay elements 2.2 of different shapes and sizes are provided. They are confined to a border region of the underlayer 2, extending up to 2 or 3 mm away from the outer edge of the underlayer 2. Therein, inlay elements 2.2 include particle-like inlay elements 2.2c, which may include rubber and/or rubber powder and/or phenolic particles. The particle-like inlay elements 2.2c may have an approximately spherical or an arbitrary shape, with a diameter of, for example, at most 100 μm or at most 50 μm. The underlayer 2 also includes elongate elements 2.2a having a diameter of at most 50 μm and a length of at most 0.1 mm. At least some of the elongate elements 2.2a in the border region of the underlayer are oriented along the z-direction. Additionally, there are further inlay elements 2.2b in the vicinity of the back plate 1, which are oriented along a direction orthogonal to the z-direction. The further inlay elements 2.2b also have a diameter of at most 50 μm and a length of at most 0.1 mm, and the further inlay elements 2.2b are also confined to the border region.

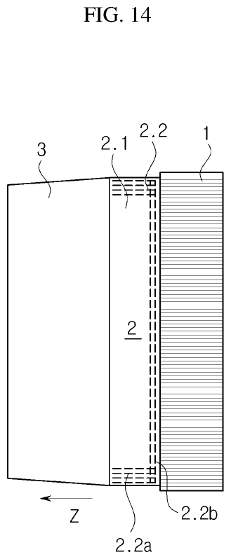

FIG. 14 shows a brake pad wherein the underlayer 2 comprises elongate elements 2.2a having a diameter of at most 50 μm and a length of at most 0.1 mm. They are confined to a border region of the underlayer 2, extending up to 2 or 3 mm from the outer edge of the underlayer 2. The elongate elements 2.2a are oriented along the z-direction. Additionally, there are further inlay elements 2.2b in the vicinity of the back plate 1, which are oriented along a direction orthogonal to the z-direction. The further inlay elements 2.2b also have a diameter of at most 50 μm and a length of at most 0.1 mm. The further inlay elements 2.2b are dispersed throughout the underlayer 2, in the vicinity of the backplate 1.

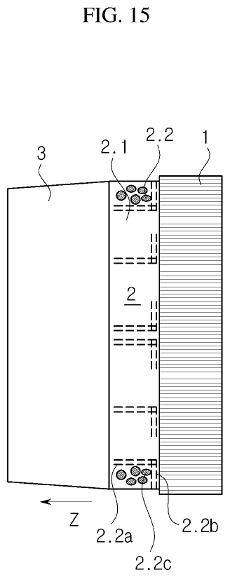

FIG. 15 shows a brake pad, wherein the underlayer 2 comprises elongate elements 2.2a having a diameter of at most 50 Linn and a length of at most 0.1 mm. The elongate elements 2.2a are oriented along the z-direction. The elongate elements 2.2a are dispersed throughout the underlayer. Additionally, there are further inlay elements 2.2b in the vicinity of the back plate 1, which are oriented along a direction orthogonal to the z-direction. The further inlay elements 2.2b also have a diameter of at most 50 μm and a length of at most 0.1 mm. The further inlay elements 2.2b are dispersed throughout the underlayer 2, in the vicinity of the backplate 1. Additionally, there are particle-like inlay elements 2.2c with an approximately spherical or an arbitrary shape, with a diameter of, for example, at most 100 μm or at most 50 μm, the particle-like inlay elements 2.2c being disposed in the border region of the underlayer 2, extending up to 2 or 3 mm from the outer edge of the underlayer 2.

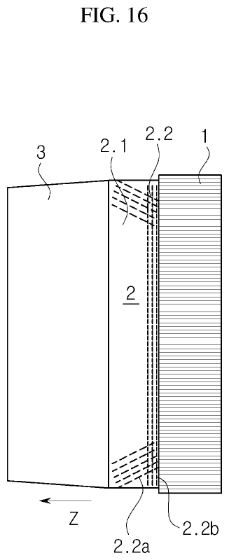

FIG. 16 shows a brake pad, wherein the underlayer 2 comprises elongate elements 2.2a having a diameter of at most 50 μm and a length of at most 0.1 mm. They are confined to a border region of the underlayer 2, extending up to 2 or 3 mm from the outer edge of the underlayer 2. The elongate elements 2.2a are oriented along a direction which slightly deviates from the z-direction, by 30 degrees or less. Therein, the elongated elements 2.2a are angled outwards, towards the outer edge of the underlayer 2, in the positive z-direction. Additionally, the underlayer 2 comprises dust 2.2d, which is dispersed throughout the underlayer 2, but confined to the vicinity of the back plate 1, up to 0.5 mm from the back plate 1.

What is claimed is:

1. A brake pad for a vehicle brake, comprising a back plate, an underlayer, and a friction material, stacked in this order, in a z-direction, wherein the brake pad is configured to be moved in the z-direction to be pressed against a rotating body for braking, the underlayer having an anisotropic material property, at least one material parameter having a value in the z-direction that is different from its value in a direction orthogonal to the z-direction.

2. The brake pad according to claim 1, wherein the anisotropic material property is provided by
an anisotropic modulus of elasticity, and/or
an anisotropic shear modulus, and/or
an anisotropic Poisson's ratio, and/or
an anisotropic thermal conductivity, and/or
an anisotropic thermal expansion, and/or
an anisotropic compressibility, and/or
an anisotropic storage modulus, and/or
an anisotropic loss modulus.

3. The brake pad according to claim 1, wherein the underlayer comprises a base material and inlay elements disposed in the base material.

4. The brake pad according to claim 3, wherein the inlay elements comprise rubber and/or minerals, such as stone, and/or glass and/or metal, such as steel, and/or phenol.

5. The brake pad according to claim 3, wherein at least some of the inlay elements are elongated elements, such as fibers or sticks.

6. The brake pad according to claim 5, wherein the elongated elements are oriented in a principal direction.

7. The brake pad according to claim 6, wherein the elongated elements extend in the z-direction.

8. The brake pad according to claim 7, wherein at least some of the inlay elements, for example the elongated elements, have a diameter of 40 μm to 110 μm and/or a length of 0.4 mm to 3 mm.

9. The brake pad according to claim 3, wherein at least some of the inlay elements have a diameter of at most 50 μm and/or a length of at most 0.1 mm not oriented in a principal direction.

10. The brake pad according to claim 3, wherein a higher density of inlay elements is provided in a border area near outer edges of the underlayer than in a central area of the underlayer, the inlay elements in the border area framing the central area of the underlayer and/or a higher density of inlay elements is provided in a vicinity of a backplate.

11. The brake pad according to claim 10, wherein the border area is confined to a distance of at most 4 mm from an outer edge of the underlayer and/or the vicinity of the backplate is confined to a distance of at most 0.5 mm from the backplate.

12. The brake pad according to claim 10, wherein a distance between neighboring inlay elements in the border area is on average less than 0.5 mm, at least some of the neighboring inlay elements in the border area contacting each other.

13. The brake pad according to claim 3, wherein the thermal expansion coefficient of the inlay elements is at least twice the thermal expansion coefficient of the base material, preferably at least three times the thermal expansion coefficient of the base material.

14. The brake pad according to claim 3, wherein, upon heating, a material of the inlay elements has a thermal expansion of 1.0 E-1/K to 1.4 E-5 1/K and/or the base material has a thermal expansion of 0.2 E-5 1/K to 0.4 E-5 1/K and/or upon cooling, the material of the inlay elements has a thermal contraction of −3 E-6 1/K to −5 E-6 1/K and/or the base material has a thermal contraction of −1.2 E-6 to −1.6 E-6 1/K.

15. The brake pad according to claim 3, wherein a density of inlay elements in the form of mineral fibers, in the underlayer is 10% to 40%.

16. The brake pad according to claim 1, wherein the underlayer is configured to expand in the z-direction by at least 0.1 mm or at least 0.2 mm when heated from 20° C. to 150° C., the expansion counteracting a pressure of at least 5 bars, a thickness of the underlayer being 1.5 mm to 3.5 mm.

17. The brake pad according to claim 1, wherein the underlayer is configured to expand by 0.03 mm to 0.05 mm in the x-direction and/or in the y-direction, when heated from 20° C. to 150° C.

18. The brake pad according to claim 1, wherein a resistance against compressibility of the underlayer is 0.0008 mm³/bar to 0.0012 mm³/bar.

19. The brake pad according to claim 3, wherein the underlayer, in particular the base material of the underlayer, comprises at least one of:
rubber,
adhesive,
phenol,
metal particles,
glass particles,
sand particles,
organic particles,
plastic particles.
